(19) United States
(12) Patent Application Publication
(10) Pub. No.: US 2026/0141242 A1
(43) Pub. Date: May 21, 2026

(54) METHOD AND A SYSTEM FOR CONTROLLING COMPUTATIONS DURING A TRAINING PROCESS OF A MACHINE-LEARNING ALGORITHM

(71) Applicant: Y.E. Hub Armenia LLC, Yerevan (AM)

(72) Inventor: Mikhail KHRUSHCHEV, Moscow (RU)

(21) Appl. No.: 19/390,159

(22) Filed: Nov. 14, 2025

(30) Foreign Application Priority Data
Nov. 15, 2024 (RU) 2024134275

(51) Int. Cl. G06N 3/084

(52) U.S. Cl. CPC G06N 3/084

(57) ABSTRACT

A method and a system for controlling computations performed during a backward pass of a training process of a given machine-learning (ML) model are provided. The method comprises: prior to executing the backward pass: identifying, in the computations of the respective portion of the parameters of a given layer of the given ML model to be executed by a given processing unit (PU), a respective set of time-independent computations; grouping respective sets of time-independent computations from each one of the plurality of PUs over each one of the plurality of layers to be executed by one selected from the group consisting of (i) prior to executing the computations of the parameters of a terminal layer of the plurality of layers; and (ii) after executing the computations of the parameters of an initial layer of the plurality of layers; and causing executing the backward pass.

### CROSS-REFERENCE

The present application claims priority to Russian Patent Application No. 2024134275, entitled “Method and a System for Controlling Computations During a Training Process of a Machine-Learning Algorithm”, filed November 15, 2024, the entirety of which is incorporated herein by reference.

### TECHNICAL FIELD

The present technology generally relates to controlling computations during a training process of a Machine-Learning Algorithm (MLA); and more specifically, to methods and systems of controlling communications during a backward pass of the training process of the MLA.

### BACKGROUND

Training machine-learning (ML) models using a plurality of processing units (PUs), such as one of Central Processing Units (CPU) and Graphics Processing Units (CPUs), can significantly accelerate computations by distributing computations of parameters of a given ML model across the plurality of PUs. However, without proper optimization of computational resources, this approach may face certain technical challenges. In other words, when the PUs are not efficiently managed, memory overhead and redundant data transfers can hinder the performance of the training process.

More specifically, if the given ML model is a neural network, for example, computations of activations during a forward pass and gradients – during a backward pass, as well as updating node weights of the neural network may need frequent synchronization across the plurality of the PUs, which may lead to communication bottlenecks. This may result in inefficient use of the internal memory of the PU and computational power, ultimately slowing down the training process, which may further hinder the scalability of the given ML model.

Certain prior art approaches have been proposed to address the above-identified technical problem.

An article entitled “ZeRO: Memory Optimizations Toward Training Trillion Parameter Models,” authored by Rajbhandari et al. and published on arxiv.org on October 04, 2019, discloses a Zero Redundancy Optimizer (ZeRO) solution for optimizing memory, improving training speed while increasing the model size that can be efficiently trained by progressively breaking down computations of the model’s parameters, gradients, and optimizer states among multiple GPUs. According to the authors, ZeRO eliminates memory redundancies in data- and model-parallel training while retaining low communication volume and high computational granularity, allowing us to scale the model size proportional to the number of devices with sustained high efficiency.

An article entitled “PyTorch FSDP: Experiences on Scaling Fully Sharded Data Parallel,” authored by Zhao et al. and published on arxiv.org on April 21, 2023, discloses a PyTorch Fully Sharded Data Parallel (FSDP) solution for large model training. FSDP "shards" (partitions) the model parameters, gradients, and optimizer states across GPUs. Each GPU only handles a portion of the model, reducing memory usage. FSDP was closely co-designed with several key PyTorch core components including Tensor implementation, dispatcher system, and CUDA memory caching allocator, to provide non-intrusive user experiences and high training efficiency. Additionally, FSDP natively incorporates a range of techniques and settings to optimize resource utilization across a variety of hardware configurations. The experimental results demonstrate that FSDP is capable of achieving comparable performance to Distributed Data Parallel while providing support for significantly larger models with near-linear scalability in terms of trillion floating-point operations per second.

### SUMMARY

It is an object of the present technology to address at least some shortcomings associated with the prior art.

Developers of the present technology have realized that the efficiency of the training process of the given ML model can be improved if certain iterative computations that are executed during a backward pass of the training process of the given ML model, were grouped for a bulk execution. These computations, also referred to herein as “time-independent computations,” can include, for example, a pre-division of gradients that is executed on each layer of the given ML model during the backward pass of the training process. Other examples of the time-independent computations include gradients of learnable parameters of LayerNorm and RMSNorm computations.

Thus, the developers have developed methods and systems directed to re-arranging the time-independent computations to be executed, during a given training iteration, either prior to or after the execution of the backward pass of the given training iteration. This can minimize downtime, thereby saving computation resources of the plurality of PUs and increasing the overall efficiency of the training process.

More specifically, in accordance with a first broad aspect of the present technology, there is provided a computer-implemented method for controlling computations performed during a backward pass of a training process of a given machine-learning (ML) model. The training process is executed using a plurality of processing units (PUs) such that a given PU of the plurality of PUs is configured to execute computations of a respective portion of parameters of a given layer of a plurality of layers of the given ML model. The method comprises: prior to executing the backward pass: identifying, in the computations of the respective portion of the parameters of the given layer to be executed by the given PU, a respective set of time-independent computations, a given time-independent computation of the set of time-independent computations being to be executed without influencing the computations of the parameters on any other layer of the plurality of layers of the given ML model; grouping respective sets of time-independent computations from each one of the plurality of PUs over each one of the plurality of layers to be executed by one selected from the group consisting of (i) prior to executing the computations of the parameters of a terminal layer of the plurality of layers; and (ii) after executing the computations of the parameters of an initial layer of the plurality of layers, thereby: removing the set of time-independent computations from the computations of the respective portion of parameters to be executed by the given PU; and generating a respective updated portion of the computations, without the set of time-independent computations, to be executed by the given PU; scheduling the respective updated portion of the computations to be executed by the given PU; and causing executing the backward pass.

In some implementations of the method, the given ML model is a neural network.

In some implementations of the method, the neural network is a Transformer-based neural network.

In some implementations of the method, the Transformer-based neural network is a Large Language Model (LLM).

In some implementations of the method, the given PU is a Graphics PU (GPU).

In some implementations of the method, the set of time-independent computations includes at least one selected from the group consisted of: (i) computations of learnable parameters of a Root Mean Square Layer Normalization (RMSNorm) computation of the given layer; (ii) computations of learnable parameters of a Layer Normalization (LayerNorm) computation of the given layer; and (iii) and a pre-division of gradients of the given layer.

In some implementations of the method, the method further comprises executing the pre-division of the gradients of each one of the plurality of layers after the executing the computations of the parameters of the initial layer of the plurality of layers during the backward pass.

In some implementations of the method, the method further comprises grouping the learnable parameters of the RMSNorm and LayerNorm computations across each one of the plurality of layers prior to the executing the computations of the parameters of the terminal layer of the plurality of layers during the backward pass; and reducing gradients of the learnable parameters of the RMSNorm and LayerNorm computations after the executing the computations of the parameters of the initial layer of the plurality of layers during the backward pass.

In some implementations of the method, the grouping the learnable parameters of the RMSNorm and LayerNorm computations across each one of the plurality of layers prior to the executing the computations of the parameters of the terminal layer of the plurality of layers comprises grouping the learnable parameters of the RMSNorm and LayerNorm computations across each one of the plurality of layers prior to executing a forward pass of the training process, the forward pass being executed prior to the executing the backward pass of the training process.

In some implementations of the method, the learnable parameters of the RMSNorm and LayerNorm computations include at lats one selected from the group consisting of: (i) a scaling parameter; and (ii) a shifting parameter.

Further, in accordance with a second broad aspect of the present technology, there is provided a server for controlling computations performed during a backward pass of a training process of a given machine-learning (ML) model. The training process is executed using a plurality of processing units (PUs) such that a given PU of the plurality of PUs is configured to execute computations of a respective portion of parameters of a given layer of a plurality of layers of the given ML model. The server comprises at least one processor and at least one non-transitory computer-readable memory, storying executable instructions, which, upon execution by the at least one processor, cause the server to, prior to executing the backward pass: identify, in the computations of the respective portion of the parameters of the given layer to be executed by the given PU, a respective set of time-independent computations, a given time-independent computation of the set of time-independent computations being to be executed without influencing the computations of the parameters on any other layer of the plurality of layers of the given ML model; group respective sets of time-independent computations from each one of the plurality of PUs over each one of the plurality of layers to be executed by one selected from the group consisting of (i) prior to executing the computations of the parameters of a terminal layer of the plurality of layers; and (ii) after executing the computations of the parameters of an initial layer of the plurality of layers, thereby: removing the set of time-independent computations from the computations of the respective portion of parameters to be executed by the given PU; and generating a respective updated portion of the computations, without the set of time-independent computations, to be executed by the given PU; schedule the respective updated portion of the computations to be executed by the given PU; and cause executing the backward pass.

In some implementations of the server, the given ML model is a neural network.

In some implementations of the server, the neural network is a Transformer-based neural network.

In some implementations of the server, the Transformer-based neural network is a Large Language Model (LLM).

In some implementations of the server, the given PU is a Graphics PU (GPU).

In some implementations of the server, the set of time-independent computations includes at least one selected from the group consisted of: (i) computations of learnable parameters of a Root Mean Square Layer Normalization (RMSNorm) computation of the given layer; (ii) computations of learnable parameters of a Layer Normalization (LayerNorm) computation of the given layer; and (iii) and a pre-division of gradients of the given layer.

In some implementations of the server, the executable instructions further cause the server to execute the pre-division of the gradients of each one of the plurality of layers after the executing the computations of the parameters of the initial layer of the plurality of layers during the backward pass.

In some implementations of the server, the executable instructions further cause the server to: group the learnable parameters of the RMSNorm and LayerNorm computations across each one of the plurality of layers prior to the executing the computations of the parameters of the terminal layer of the plurality of layers during the backward pass; and reduce gradients of the learnable parameters of the RMSNorm and LayerNorm computations after the executing the computations of the parameters of the initial layer of the plurality of layers during the backward pass.

In some implementations of the server, to group the learnable parameters of the RMSNorm and LayerNorm computations across each one of the plurality of layers prior to the executing the computations of the parameters of the terminal layer of the plurality of layers the executable instructions cause the server to group the learnable parameters of the RMSNorm and LayerNorm computations across each one of the plurality of layers prior to executing a forward pass of the training process, the forward pass being executed prior to the executing the backward pass of the training process.

In some implementations of the server, the learnable parameters of the RMSNorm and LayerNorm computations include at lats one selected from the group consisting of: (i) a scaling parameter; and (ii) a shifting parameter.

In the context of the present specification, a “server” is a computer program that is running on appropriate hardware and is capable of receiving requests (e.g. from electronic devices) over the network, and carrying out those requests, or causing those requests to be carried out. The hardware may be one physical computer or one physical computer system, but neither is required to be the case with respect to the present technology. In the present context, the use of the expression a “at least one server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, unless provided expressly otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that the use of the terms “first server” and “third server” is not intended to imply any particular order, type, chronology, hierarchy or ranking (for example) of/between the server, nor is their use (by itself) intended to imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

In the context of the present specification, "electronic device" is any computer hardware that is capable of running software appropriate to the relevant task at hand. In the context of the present specification, the term "electronic device" implies that a device can function as a server for other electronic devices, however it is not required to be the case with respect to the present technology. Thus, some (non-limiting) examples of electronic devices include self-driving unit, personal computers (desktops, laptops, netbooks, etc.), smartphones, and tablets, as well as network equipment such as routers, switches, and gateways. It should be understood that in the present context the fact that the device functions as an electronic device does not mean that it cannot function as a server for other electronic devices.

In the context of the present specification, the expression "information" includes information of any nature or kind whatsoever capable of being stored in a database. Thus, information includes, but is not limited to visual works (e.g. maps), audiovisual works (e.g. images, movies, sound records, presentations etc.), data (e.g. location data, weather data, traffic data, numerical data, etc.), text (e.g. opinions, comments, questions, messages, etc.), documents, spreadsheets, etc.

In the context of the present specification, a "database" is any structured collection of data, irrespective of its particular structure, the database management software, or the computer hardware on which the data is stored, implemented, or otherwise rendered available for use. A database may reside on the same hardware as the process that stores or makes use of the information stored in the database or it may reside on separate hardware, such as a dedicated server or plurality of servers.

Implementations of the present technology each have at least one of the above-mentioned objects and/or aspects, but do not necessarily have all of them. It should be understood that some aspects of the present technology that have resulted from attempting to attain the above- mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE FIGURES

These and other features, aspects and advantages of the present technology will become better understood with regard to the following description, appended claims, and accompanying drawings where:

FIG. 1 depicts a schematic diagram of an example computer system configurable for implementing certain non-limiting embodiments of the present technology;

FIG. 2 depicts a schematic diagram a GPU cluster housed within the computer system of FIG. 1, in accordance with certain non-limiting embodiments of the present technology;

FIG. 3 depicts a schematic diagram of a networked computing environment including the computer system of FIG. 1 and being suitable for use with certain non-limiting embodiments of the present technology;

FIG. 4 schematically depicts a first sequence diagram of a server present in the networked computing environment of FIG. 2 executing a backward pass during a given training iteration of a training process of a machine-learning (ML) model executed by the server, in accordance with certain prior art approaches;

FIG. 5 schematically depicts a second sequence diagram of the server present in the networked computing environment of FIG. 2 executing the backward pass during the given training iteration of the training process of the ML model, in accordance with certain non-limiting embodiments of the present technology; and

FIG. 6 depicts a flowchart diagram of the server present in the networked computing environment of FIG. 2 controlling operation to be performed during the backward pass at the given training iteration of the training process of the ML model executed by the server, in accordance with certain non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit,” may be provided through the use of dedicated hardware as well as hardware capable of executing software in association with appropriate software. When provided by a processor, the functions may be provided by a single dedicated processor, by a single shared processor, and/or by a plurality of individual processors, some of which may be shared. In some embodiments of the present technology, the processor may be a general-purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random-access memory (RAM), and/or non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Computer System

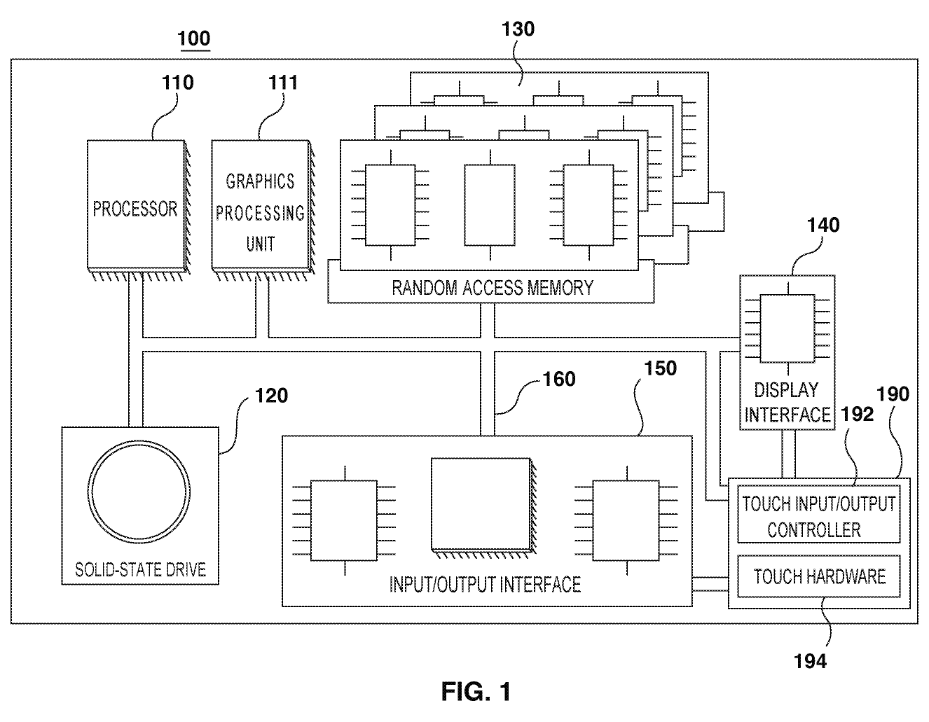

With reference to FIG. 1, there is depicted a computer system 100 suitable for use with some implementations of the present technology. The computer system 100 comprises various hardware components including one or more single- or multi-core processors collectively represented by a central processing unit (CPU) 110, a graphics processing unit (GPU) 111, a solid-state drive 120, a random-access memory 130, a display interface 140, and an input/output interface 150.

Communication between the various components of the computer system 100 may be enabled by one or more internal and/or external buses 160 (e.g., a PCI bus, universal serial bus, IEEE 1394 “Firewire” bus, SCSI bus, Serial-ATA bus, etc.), to which the various hardware components are electronically coupled.

The input/output interface 150 may be coupled to a screen 190 and/or to the one or more internal and/or external buses 160. In some non-limiting embodiments of the present technology, the screen 190 can be implemented as a touch screen and hence comprise touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In some non-limiting embodiments of the present technology, the input/output interface 150 may be connected to a keyboard (not separately depicted), a mouse (not separately depicted) or a trackpad (not separately depicted) allowing the user to interact with the computer system 100 in addition to or instead of the screen 190.

It is noted some components of the computer system 100 can be omitted in some non-limiting embodiments of the present technology. For example, the keyboard and the mouse (both not separately depicted) can be omitted, especially (but not limited to) where the computer system 100 is implemented as a compact electronic device, such as a smartphone.

According to implementations of the present technology, the solid-state drive 120 stores program instructions suitable for being loaded into the random-access memory 130 and executed by the CPU 110 and/or the GPU 111. For example, the program instructions may be part of a library or an application.

In some non-limiting embodiments of the present technology, the GPU 111 can comprise a single GPU chip. According to certain non-limiting embodiments of the present technology, the single GPU chip can have, for example, from about 1000 to about 5000 GPU cores. In some non-limiting embodiments of the present technology, the single GPU chip can include about 6900 GPU cores. In yet other non-limiting embodiments of the present technology, the single GPU chip can include about 8700 GPU cores. In yet further non-limiting embodiments of the present technology, the single GPU chip can include about 10500 GPU cores. In a specific non-limiting example, the single GPU chip can be implemented as an Nvidia Tesla V100 available from Nvidia Corporation of 2788 San Tomas Expressway, Santa Clara, California, 95051, USA. It should be expressly understood that the single GPU chip can be implemented in any other suitable equipment.

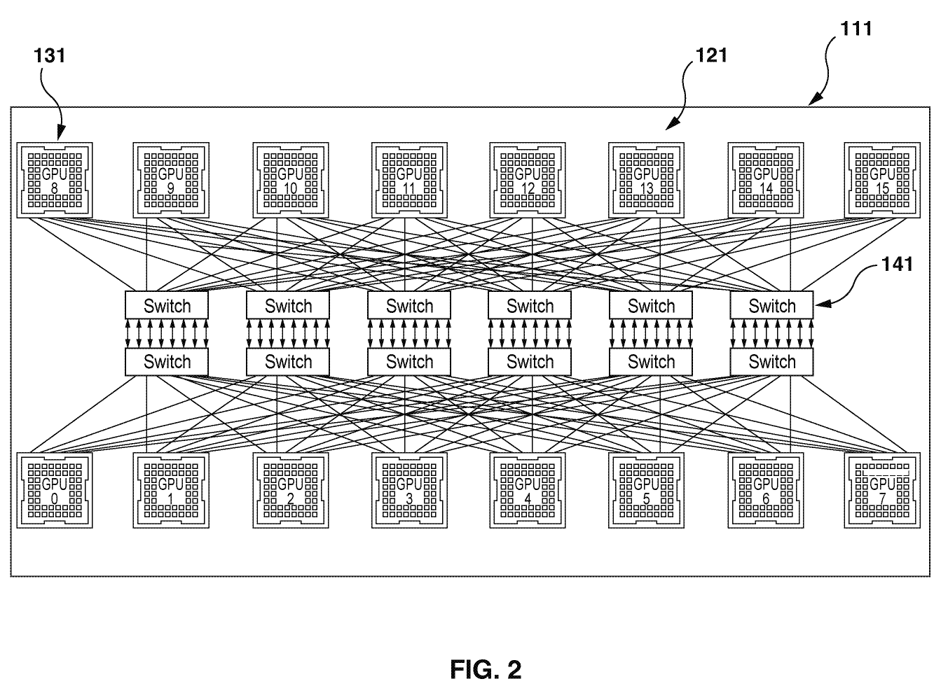

In other non-limiting embodiments of the present technology, the GPU 111 can include a plurality of GPU chips, each of which can be implemented similar to the single GPU chip described above. With reference to FIG. 2, there is depicted a schematic diagram of a GPU cluster 121 housed within the GPU 111. According to certain non-limiting embodiments of the present technology, the GPU cluster 121 can include 4 GPU chips. In other non-limiting embodiments of the present technology, the GPU cluster 121 can include 8 GPU chips. In yet other non-limiting embodiments of the present technology, as illustrated in FIG. 2, the GPU cluster 121 can include 16 GPU chips. According to certain non-limiting embodiments of the present technology, a given GPU chip 131 of the GPU cluster 121 can be mounted on a respective Printed Circuit Board (PCB) and coupled to other GPU chips (not separately numbered) via GPU switches, such as a given GPU switch 141.

How a communication link between the given GPU chip 131 of the GPU cluster 121 and the given GPU switch 141 is implemented is not limited and depends generally on a particular implementation of the given GPU switch 141. For example, in those embodiments where the given GPU switch 141 is implemented as a NVSwitch^{TM} GPU switch, the communication link therebetween and the given GPU chip 131 can include an NVLink^{TM} communication link. In other non-limiting embodiments of the present technology, where the given GPU switch 141 is implemented as a Peripheral Component Interconnect Express (PCIe^{TM}) GPU switch, the communication link therebetween and the given GPU chip 131 can include a PCIe^{TM} communication link. In yet other non-limiting embodiments of the present technology, where the given GPU switch 141 is implemented as an InfiniBand^{TM} GPU switch, the communication link therebetween and the given GPU chip 131 can include an InfiniBand^{TM} communication link.

In a specific non-limiting example, the GPU cluster 121 can be implemented as an Nvidia DGX-2 available from Nvidia Corporation of 2788 San Tomas Expressway, Santa Clara, California, 95051, USA. It should be expressly understood that the GPU cluster 121 can be implemented in any other suitable equipment.

Further, akin to the GPU 111, in some non-limiting embodiments of the present technology, the CPU 110 can comprise a single CPU chip, including a plurality of CPU cores, such as 2, 4, 16, 32, or 64 CPU cores, as an example. However, in other non-limiting embodiments of the present technology, the CPU 110 can comprise a CPU cluster including a plurality of single- or multi-core CPU chips (not depicted), including up to hundreds or even thousands of CPU chips. In a specific non-limiting example, the CPU cluster can be implemented as an HPE Apollo 6500 Gen10 Plus System available from Hewlett Packard Enterprise (HPE) of 6280 America Center Drive, San Jose, CA 95002, USA. It should be expressly understood that the CPU cluster can be implemented in any other suitable equipment.

### Networked Computing Environment

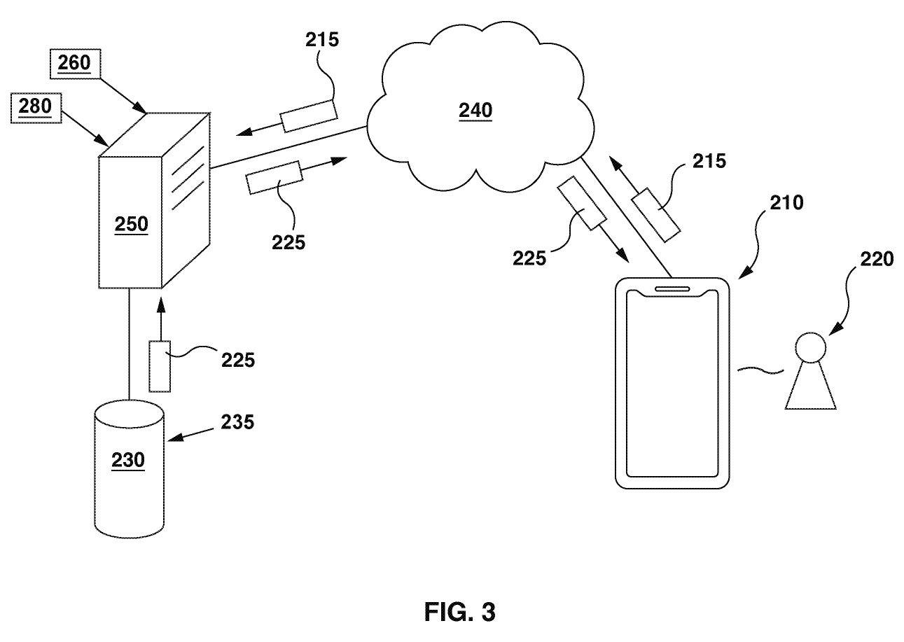

With reference to FIG. 3, there is depicted a schematic diagram of a networked computing environment 200 suitable for use with some non-limiting embodiments of the present technology. The networked computing environment 200 includes an electronic device 210 communicatively coupled, via a communication network 240, with a server 250. In the non-limiting embodiments of the present technology, the electronic device 210 may be associated with a user 220.

In the non-limiting embodiments of the present technology, the electronic device 210 may be any computer hardware that is capable of running a software appropriate to the relevant task at hand. Thus, some non-limiting examples of the electronic device 210 may include personal computers (desktops, laptops, netbooks, etc.), smartphones, and tablets. Thus, the electronic device 210 may comprise some or all components of the computer system 100 depicted in FIG. 1.

According to certain non-limiting embodiments of the present technology, the server 250 can be configured to host a digital platform 260; and the CPU 110 of the electronic device 210 can be configured to access the digital platform 260 via the communication network 240. Broadly speaking, the digital platform 260 is a web resource providing the user 220 with access to a plurality of digital documents 235 stored in a database 230 communicatively coupled to the server 250 via a respective communication link. More specifically, in response to a given user request 215, the digital platform 260 can be configured to identify a set of digital documents 225 that may interest the user 220 and further transmit the indications of such digital documents to the electronic device 210 for user’s appreciation.

In some non-limiting embodiments of the present technology, the server 250 can be implemented as a conventional computer server and may comprise some or all of the components of the computer system 100 of FIG. 1. In one non-limiting example, the server 250 is implemented as a Dell™ PowerEdge™ Server running the Microsoft™ Windows Server™ operating system but can also be implemented in any other suitable hardware, software, and/or firmware, or a combination thereof. In the depicted non-limiting embodiments of the present technology, the server 250 is a single server. In alternative non-limiting embodiments of the present technology (not depicted), the functionality of the server 250 may be distributed and may be implemented via multiple servers.

In some non-limiting embodiments of the present technology, the server 250 can be operated by the same entity that has provided the digital platform 260. For example, if the digital platform 260 is a Yandex.Music^{TM} audio streaming platform, the server 250 can also be operated by Yandex LLC of 16 Lev Tolstoy Street, Moscow, 119021, Russia. In alternative non-limiting embodiments of the present technology, the server 250 can be operated by an entity different from the one that has provided the digital platform 260.

### Communication Network

In some non-limiting embodiments of the present technology, the communication network 240 is the Internet. In alternative non-limiting embodiments of the present technology, the communication network 240 can be implemented as any suitable local area network (LAN), wide area network (WAN), a private communication network or the like. It should be expressly understood that implementations for the communication network are for illustration purposes only. How a respective communication link (not separately numbered) between each one of the electronic device 210, the server 250, and the communication network 240 is implemented will depend, inter alia, on how each one of the electronic device 210 and the server 250 is implemented. Merely as an example and not as a limitation, in those embodiments of the present technology where the electronic device 210 is implemented as a wireless communication device such as the smartphone, the communication link can be implemented as a wireless communication link. Examples of wireless communication links include, but are not limited to, a 3G communication network link, a 4G communication network link, and the like. The communication network 240 may also use a wireless connection with the server 250.

### Digital Platform and Machine-Learning Model

As the plurality of digital documents 235 can includes hundreds of thousands, millions, tens or even hundreds of millions of digital documents, to aid the user 220 in navigating through the plurality of digital documents 235 and provide the set of digital documents 225 that would be closely responsive to the given user request 215, according to certain non-limiting embodiments of the present technology, the server 250 can be configured to execute a machine-learning (ML) model 280.

A target of the ML model 280 is not limited and depends broadly on an implementation of the digital platform 260. According to some non-limiting embodiments of the present technology, the digital platform 260 can comprise a digital recommendation platform. For example, the digital recommendation platform can comprise an audio streaming platform, such as a Spotify^{TM} audio streaming platform, a Yandex^{TM} Music^{TM} audio streaming platform, and the like, with the plurality of digital documents 235 including various audio digital documents, such as audio tracks, audio books, podcasts, and the like. In another example where the digital recommendation platform is a video hosting platform or a video streaming platform, such as a YouTube^{TM} video hosting platform or a Netflix^{TM} video streaming platform, for example, and the plurality of digital documents 235 can include various video digital documents, such as video clips, movies, news footages, and the like. In yet other example, where the digital platform is implemented as an online listing platform, such as a Yandex^{TM} Market^{TM} online listing platform, an Avito^{TM} online listing platform, and the like, the plurality of digital documents can include advertisements of various items offered for sale, such as goods and services.

In other non-limiting embodiments of the present technology, the digital platform 260 can be implemented as a search engine (such as a Google^{TM} search engine, a Yandex^{TM} search engine, and the like), and the plurality of digital documents 235 can include web document that can further include digital documents of all the above listed types. It should be expressly understood that other implementations of the digital platform 210 as well as other respective types of digital documents hosted thereby are also envisioned.

Thus, in these embodiments, the ML model 280 can be trained to identify the set of digital documents 235, responsive to the given user request, that would include digital documents similar to those, with which the user 220 has interacted in the past, and/or with which users, similar to the user 220, have interacted in the past. In these embodiments the ML model 260 can be trained and used, for example, as described in a co-owned United States Patent Application Publication No.: 2024/0256558-A1, published on August 01, 2024, the content of which is incorporated herein by reference in its entirety.

In other non-limiting embodiments of the present technology, the digital platform 260 can be implemented as a virtual assistant application (also known as a “chatbot” application), such as Yandex^{TM} ALISA^{TM} virtual assistant application, or Amazon^{TM} ALEXA^{TM} virtual assistant application, that can be used for navigating the user 220 through a respective online service (such as online shopping, medical clinic, and others) and completing their requests thereat. Thus, in these embodiments, the ML model 280 can be implemented as at least one of: (1) a Speech-To-Text (STT) model, trained to convert a user utterance, representative of the given user request 215, produced by the user 220, to a textual representation (not depicted) of the given user request 215; (2) a Natural Language Processing (NLP) model, trained to understand the textual representation of the given user request 215 and generate a machine- generated text string (not depicted) responsive to the given user request 215; and (3) a Text-To-Speech (TTS) model, trained to convert the machine-generated text string into an instance of natural language speech (not depicted) for playing back to the user 220. In these embodiments, the ML model 280 can be trained and used, for example, as described in a co-owned United States Patent Application Publication No.: 2023/0206910-Al, published on June 29, 2023, the content of which is incorporated herein by reference in its entirety.

In some non-limiting embodiments of the present technology, the ML model 280 can comprise a neural network (NN), such as a Recurrent NN or a Long Short-Term Memory (LSTM) NN. In some non-limiting embodiments of the present technology, the ML model 280 can comprise a Transformer-based NN as described, for example, in an article by Vaswani et al. “Attention Is All You Need,” and published in the Proceedings of 31st Conference on Neural Information Processing Systems (NIPS 2017), the content of which is incorporated herein by reference in its entirety. Modifications of the of the Transformer-based NN, envisioned for implementing the ML model 280, without departing from the scope of the present technology, include, for example: (1) a Generative Pretrained Transformer (GPT), as described, for example, in an article authored by Radford et al. “Improving Language Understanding by Generative Pre-Training,” published by OpenAI in June 218, the content of which is incorporated herein by its entirety; and (2) a Bidirectional Encoder Representations from Transformers (BERT) model as described, for example, in an article authored by Devlin et al. “BERT: Pre-training of Deep Bidirectional Transformers for Language Understanding,” published Proceedings of the 2019 Conference of the North American Chapter of the Association for Computational Linguistics (NAACL) in June 2019, the content of which is incorporated herein by reference in its entirety. Further, in these embodiments, an architecture of the ML model 280 can comprise a plurality of layers including 12, 24, 36, 40, 48, 60, 80, 96, or even 100 layers.

Thus, in the embodiments where the ML model 280 is the Transformer-based NN, the ML model 280 can be implemented as a Large Language Model (LLM), such as a ChatGPT^{TM} LLM or a LLaMA^{TM} LLM, trained to understand human utterances representative of the given user request 215 and generate instances of human-like language for the tasks of virtual personal assistance, translation, text summarization, and research conduction.

Broadly speaking, the server 250 can be said to be executing two respective processes in respect of the ML model 280 for the purposes of the digital platform 260. A first process of the two processes is a training process, where the server 250 is configured to train the ML model 280, based on a training set of data, to generate a respective target output, depending on a particular implementation of the digital platform 260, as mentioned above. A second process is an in-use process, where the server 250 executes the so-trained ML model 280 to generate the respective target output for responding to the given user request 215.

According to certain non-limiting embodiments of the present technology, the training set of data comprise a plurality of training digital objects. In those embodiments of the present technology where the ML model 280 is an LLM that is configured to generate a next sentence or complete a given sentence, the server 250 can be configured to obtain the training set of data from various corpora of naturally generated and publicly available text, derived from literature, song lyrics, scientific publications, blog posts, and the like. In these embodiments, a given training digital object of the plurality of training digital objects can include: (1) a first sentence, such as “Rain drops keep falling on my head;” and (2) a respective label including a second sentence, following the first sentence, such as “And just like the guy whose feet are too big for his bed.” In those embodiments where the LLM is to be trained for translating texts, the server 250 can be configured to obtain the training text of data from two parallel corpora of naturally generated text in a source language (such as Russian) and in a target language (such as English). In these embodiments, the given training digital object of the plurality of training digital objects can include: (1) the first sentence in the source language, such as “ Нас не догонят ;” and (2) the respective label including the second sentence, which is a translation of the first sentence into the target language, such as “Not gonna get us.” Further, during the training process, the server 250 can be configured to: (i) feed the first sentence to the ML model 280, thereby causing the ML model 280 to generate a respective output; and (ii) compare the respective output with the second sentence of the respective label.

More specifically, according to certain non-limiting embodiments of the present technology, during the training process, at each training iteration, the server 250 can be configured to execute a forward pass and a backward pass of the ML model 280. More specifically, during the forward pass of a given training iteration, the server 250 can be configured to: (i) obtain the given training digital object of the training set of data; (ii) tokenize the first sentence from the given training digital object into tokens, that is, smaller textual units, such as words or morphemes; (iii) generate, using a text embedding algorithm (such as a Word2Vec text embedding algorithm), for each token of the first sentence, a respective vector embedding; (iv) process vector representation of the first sentence layer-by-layer, generating, at a given layer of the plurality of layers of the ML model 280, a respective set of activations, representative of current node weights of the given layer; and (v) generate a final set of activations, representative of the respective output of the ML model 280.

Further, during the backward pass of the given training iteration, the server 250 can be configured to: (i) determine a difference between the respective output of the ML model 280, generated in response to the given training digital object, and the respective label thereof, which can be expressed by a loss function (such as a cross-entropy loss, for example); (ii) determine gradients of the loss function with respect to each parameter of the ML model 280 through a backpropagation algorithm; and (iii) using an optimizer (such as an Adam optimization algorithm), update the parameters of the ML model 280 based on the determined gradients.

However, in some non-limiting embodiments of the present technology, where the ML model 280 comprise an LLM, the ML model 280 can comprise hundreds of millions of parameters (that is, node weights and biases of the ML model 280, for example), such as from about 110 to 340 million parameters. In some non-limiting embodiments of the present technology, the ML model 280 can include billions of parameters, such as from 7 to 65 billion parameters. In yet other non-limiting embodiments of the present technology, the ML model 280 can include hundreds of billions of parameters, such as from 100 to 300 billion parameters. Given such large numbers of parameters of the ML model 280, there may arise certain limitations of computational and memory resources of the server 250, particularly in one of the CPU 110 or the GPU 111.

According to one conventional approach⸺for example, the FSDP approach by Zhao et al., referenced above⸺to address memory overhead and minimize redundant storage of activations, gradients, and optimizer states, at the given training iteration, the server 250 can be configured to shard the parameters of the ML model 280 among multiple Processing Units (PUs), such as chips of one of the CPU cluster (not depicted) and GPU cluster 121 described above. For the simplicity and clarity of explanation of the non-limiting embodiments of the present technology, the description provided hereinbelow will describe the training process executed by the GPU cluster 121 of the GPU 111. However, it must be expressly understood that, in some non-limiting embodiments of the present technology, the server 250 can be configured to execute the training process using the CPU cluster of the CPU 110.

More specifically, during the forward pass of the given training iteration of the training process, according to the FSDP approach, the server 250 can be configured to: (i) partition parameters of the given layer into respective sets of parameters across GPU chips of the GPU cluster 121, such as given GPU chip 131; (ii) cause the given GPU chip 131 to gather the respective sets of parameters from other GPU chips of the GPU cluster 121; (iii) cause the given GPU chip 131 to compute, based on the respective sets of parameters from the other GPU chips, a respective set of activations; (iv) store the computed respective set of activations of the given CPU chip 131 for further use during the backward pass. In some non-limiting embodiments of the present technology, to gather the respective sets of parameters of the given layer, the server 250 can be configured to cause the given GPU chip 131 to execute an all-gather operation.

Further, during the backward pass of the given training iteration, based on the so determined activations for each layer of the ML model 280, the server 250 can be configured to determine gradients and adjust the parameters of the ML model 280.

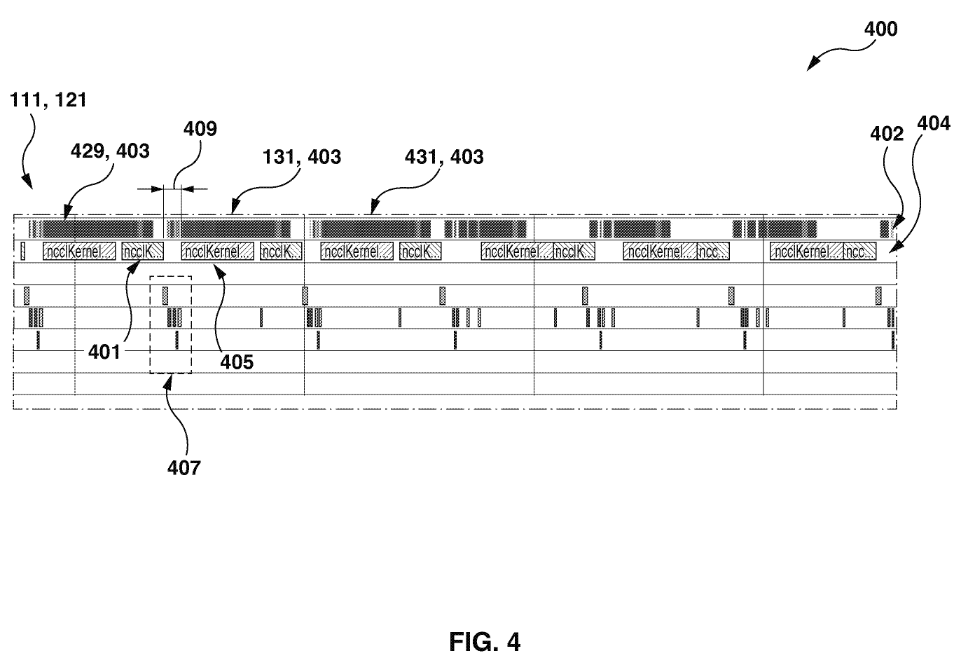

With reference to FIG. 4, there is depicted a first sequence diagram 400 of the backward pass of the training process of the ML model 280, executed by the server 250, using the GPU cluster 121, in accordance with certain non-limiting embodiments of the present technology. As it can be appreciated, the server 250 can be configured to cause each GPU chip of the GPU cluster 121 to execute a plurality of operations in streams, programmatically enabled in each GPU chip of the GPU cluster 121. For example, the server 250 can be configured to cause the GPU cluster 121 to execute: (i) parameter computations, such as those of activations or gradients as will be described below, in a computation stream 402; and (ii) communications among the GPU chips, such as those between the given GPU chip 131 and the other GPU chips of the GPU cluster 121 in a communication stream 404, operations of which can at least partially overlap with operations of the computation stream 402.

More specifically, during the backward pass, according to the FSDP approach, for the given layer of the ML model 280, the server 250 can be configured to: (i) cause the given GPU chip 131 to execute, during the communication stream 404, a respective instance of a gather operation 401 to gather respective sets of activations from the other GPU chips of the GPU cluster 121; (ii) cause the given GPU chip 131 to execute, during the computation stream 402, a respective instance of a gradient computation operation 403 to compute, based on the respective sets of activations, a respective set of gradients; (iii) and cause the given GPU chip 131 to execute, during the communication stream 404, a respective instance of synchronisation operation 405 to synchronize respective sets of gradients across the GPU chips of the GPU cluster 121, such as by summing, thereby generating, in the internal memory of the given GPU chip 131, a respective copy of global gradients of all parameters of the given layer; (iv) cause the optimizer, based on the respective copy of global gradients, adjust the set of parameters of the given GPU chip 131.

According to certain non-limiting embodiments of the present technology, the gather operation 401 can comprise the all-gather operation mentioned above with respect to the forward pass of the training process. Further, in some non-limiting embodiments of the present technology, the synchronization operation 405 can comprise an all-reduce operation. In other non-limiting embodiments of the present technology, the synchronization operation 405 can comprise a reduce-scatter operation.

However, as it can further be appreciated from FIG. 4, when the server 250 is configured to execute the backward pass according to the FSDP approach, a set of auxiliary operations 407 need to be executed between the respective instances of the gather operation 401 and the synchronization operation 405 for the give GPU chip 131. The execution of the set of auxiliary operations 407 may thus introduce a delay 409 between the respective instances of the gather operation 401 and the synchronization operation 405 during the communication stream 404, which further defers the execution of the gradient computation operation 403 on a next GPU chip 431 of the GPU cluster 121, following the given GPU chip 131 in the GPU cluster 121, during the computation stream 402. This effect, also known as a “give-way effect,” may increase the downtime, which can hence decrease the efficiency of the overall training process of the ML model 280, affecting its further scalability.

To address this technical problem, the developers of the present technology have realized that at least some of the plurality of auxiliary operations 407 between the respective gather and synchronization operations 401, 405 do not depend on a specific timing of their execution. Therefore, these computations, also referred to herein as “time-independent” operations, can be grouped and re-arranged along the computation stream 402, thereby minimizing the delay 409 between the respective instances of the gather operation 401 and the synchronization operation 405 for each GPU chip of the GPU cluster 121. This can help expedite the operations executed in the computation stream 402 the GPU cluster 121, improving the efficiency of the training process of the ML model 280 and enabling further scalability thereof.

Examples of the time-independent operations that can be identified within the plurality of auxiliary operations 407 as well as how they can be grouped and re-arranged during the given training iteration, in accordance with certain non-limiting embodiments of the present technology, will now be described.

### Backward Pass Operation Optimization

With continued reference to FIG. 4, according to certain non-limiting embodiments of the present technology, to minimize the give-way effect resulting in the delay 409 between the operations of the communication stream 404, the server 250 can be configured to identify, prior to executing the backward pass, in the plurality of auxiliary operations 407 causing the delay 409, a set of time-independent operations for further grouping and re-arrangement.

In other words, the server 250 can be configured to identify, prior to executing the backward pass, such computations of the plurality of auxiliary operations 407, execution of which: (1) would not depend on the gradient computation operation 403 executed by a preceding GPU chip 429, preceding the given GPU chip in the GPU cluster 121, and (2) would not affect the gradient computation operation 403 executed by the next GPU chip 431, following the given GPU chip 131 in the GPU cluster 121.

For example, in some non-limiting embodiments of the present technology, the server 250 can be configured to identify the set of time-independent operations after executing the forward pass but prior to the executing the backward pass of the given training iteration. In other non-limiting embodiments of the present technology, the server 250 can be configured to identify the set of time-independent operations prior to executing the forward pass of the given training iteration of the ML model 280.

In some non-limiting embodiments of the present technology, a first time-independent operation of the set of time-independent operations that the server 250 can be configured to identify in the plurality of auxiliary operations 407 can be, for example, a pre-division operation. In the context of the present specification, the pre-division operation refers to dividing the respective set of gradients computed by the given GPU chip 131 during the gradient computation operation 403 by a number of GPU chips of the GPU cluster 121 prior to executing the respective synchronization operation 405.

In some non-limiting embodiments of the present technology, a second time-independent operation of the set of time-independent operations that the server 250 can be configured to identify in the plurality of auxiliary operations 407 can be, for example, computation and update of learnable parameters of a Layer Normalization (LayerNorm) operation. In the context of the present specification, the LayerNorm operation refers to a normalization operation that is applied to an input of the given layer across all features (nodes) thereof for stabilizing the respective activations. More specifically, the LayerNorm operation includes: (i) determining a mean and a standard deviation across all the features of the given layer; and (ii) normalizing each data point of the input by subtracting therefrom the mean and dividing the difference by the standard deviation. Further, in the context of the present specification, the learnable parameters of the LayerNorm operation include: (1) a scaling parameter (γ) and (2) a shifting parameter (β). After normalizing the features of the given layer, the LayerNorm operation includes applying to each feature of the given layer at least one of the learnable parameters. According to certain non-limiting embodiments of the present technology, the server 250 can be configured to update the learnable parameters of the LayerNorm operation at each training iterations along with the other parameters of the ML model 280.

In some non-limiting embodiments of the present technology, a third time-independent operation of the set of time-independent operations that the server 250 can be configured to identify in the plurality of auxiliary operations 407 can be, for example, computation and update of the learnable parameters of a Root Mean Square Layer Normalization (RMSNorm) operation. In the context of the present specification, the RMSNorm operation refers to normalizing the input of the given layer by a Root Mean Square value of all the features of the given layer that is used, akin to the LayerNorm operation, for stabilizing the activations. Further, in the context of the present specification, the learnable parameters of the RMSNorm operation include, for example, the scaling parameter (γ). After normalizing the parameters of the given layer, the RMSNorm operation includes applying to each feature of the given layer the learnable parameters. According to certain non-limiting embodiments of the present technology, the server 250 can be configured to update the learnable parameters of the RMSNorm operation at each training iterations along with the other parameters of the ML model 280.

Further, according to certain non-limiting embodiments of the present technology, the server 250 can be configured to group instances of the set of time-independent operations, determined for each GPU chip in the GPU cluster 121, either prior to or after executing the backward pass of the given training iteration. In other words, the server 250 can be configured to group and re-arrange at least some of the set of time-independent operations by displacing them to one of: (1) prior to executing the respective instances of the gradient computation operation 403 on a terminal layer of the ML model 280; and (2) after executing the respective instances of the gradient computation operation 403 on an initial layer of the ML model 280.

More specifically, according to some non-limiting embodiments of the present technology, the server 250 can be configured to group all instances of the first time-independent operation (that is, the pre-division operation) across the plurality of layers after executing the gradient computation operation 403 on the initial layer of the ML model 280. In other words, the server 250 can be configured to move, along the computation stream 402, all the instances of the first time-independent operation across all of the plurality of layers of the ML model 280 to after all the instances of the gradient computation operations 403 on each one of the plurality of layers have been executed. By doing so, instead of averaging the gradients after each instance of the gradient computation operation 403 on each GPU chip of the GPU cluster 121, the server 250 can be configured to group all the instances of the first time-independent operation across the plurality of layers of the ML model 280 and execute them all at once. In this regard, the pre-division operation can be referred to as a “post-division” operation.

According to certain non-limiting embodiments of the present technology, the server 250 can further be configured to: (i) group instances of at least one of learnable parameters of the second time-independent operation, that is, the LayerNorm operation, in the beginning of the given training iteration, that is, prior to executing the forward pass; and (ii) compute gradients of the instances of at least one of the learnable parameters of the second time-independent operation after the backward pass of the given training iteration. In other words, akin to the first time-independent operation, instead of computing gradients and updating the at least one of the learnable parameters, such as the scaling and shifting parameters, of the LayerNorm operation at each layer, the server 250 can be configured to aggregate these parameters to cause computation of their gradients collectively, updating them all at once after the backward pass of the given training iteration.

In some non-limiting embodiments of the present technology, similar to the second time-independent operation, the server 250 can further be configured to: (i) group instances of the learnable parameters, such as the scaling parameter, of the third time-independent operation, that is, the RMSNorm operation, in the beginning of the given training iteration, that is, prior to executing the forward pass; and (ii) compute gradients of the scaling parameter of the third time-independent operation after the backward pass of the given training iteration of the training process. By doping so, akin to the first and second time-independent operations, instead of computing gradients and updating the scaling parameter of the RMSNorm operation at each layer, the server 250 can be configured to aggregate these parameters to cause computation of their gradients collectively, updating them all at once after the backward pass of the given training iteration.

After identifying the set of time-independent operations and grouping them for execution one of prior to and after the backward pass of the given training iteration during the training process of the ML model 280, according to certain non-limiting embodiments of the present technology, the server 250 can be configured to: (i) remove each instance of the set of time-independent operations from operations to be executed by each GPU chip of the GPU cluster 121; and (ii) generate, for each GPU chip, a respective updated portion of operations to be executed during the backward pass, that would be without the respective instance of the set of time-independent computations.

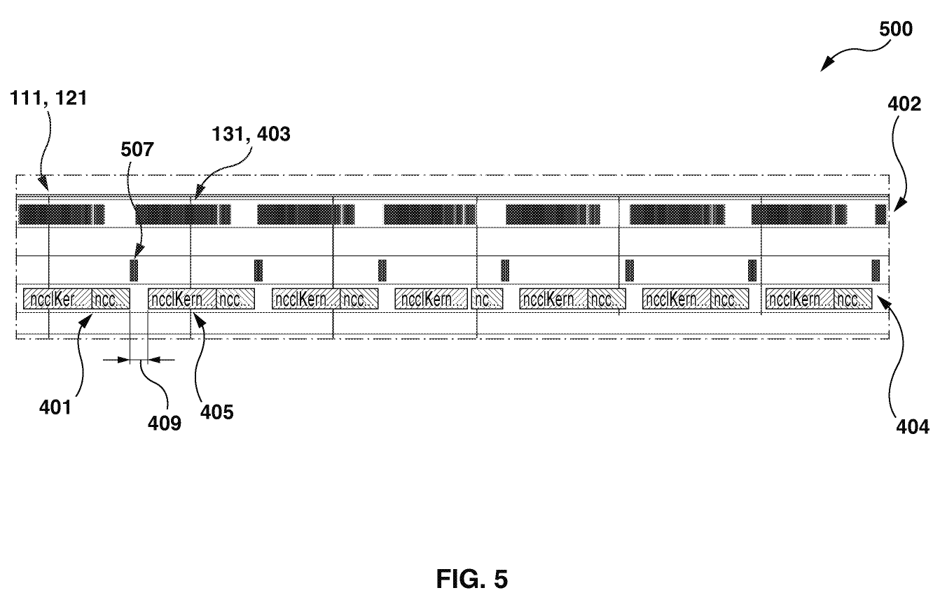

More specifically, as schematically depicted in a second sequence diagram 500 of the backward process in FIG. 5, in accordance with certain non-limiting embodiments of the present technology, by removing the respective instance of the set of time-independent operations for the given GPU chip 131 from the plurality of auxiliary computations 407 associated therewith, the server 250 can be configured to generate the respective instance of an updated plurality of auxiliary operations 507. As it can be appreciated, the updated plurality of auxiliary operations 507 is smaller than the plurality of auxiliary operation 407, which minimizes the delay 409 between the respective instances of the gather operation 401 and the synchronization operation 405 for the give GPU chip 131. This can in turn expedite the execution of the respective instances of the gradient computation operation 403 by the GPU cluster 121 in the computation stream 402.

Further, after re-arranging the instances of the set of time-independent operations and generating the updated plurality of auxiliary operations 507, according to certain non-limiting embodiments of the present technology, the server 250 can be configured to schedule the respective instances of: (1) of the gradient computation operation 403; (2) the gather operation 401; and (3) the synchronization operation 405 to be executed by each GPU chip of the GPU cluster 121 during the backward pass of the given training iteration of the training process of the ML model 280 along the computation and communication stream 402, 404, respectively. Further, the server 250 can be configured to cause execution of the backward process of the given training iteration. Further, the server 250 can be configured to schedule the respective instances of the set of time-independent operations to be executed one of prior to and after the backward pass, as described above, to be executed by the GPU cluster 121 akin to executing other operations described above.

In some non-limiting embodiments of the present technology, the server 250 can be configured to identify the respective instances of the set of time-independent operations, as described above, prior to executing the backward pass at each training iteration of the training process of the ML mode 280. In other non-limiting embodiments of the present technology, the server 250 can be configured to identify the respective instances of the set of time-independent operations, as described above, for each training iteration, prior to executing the training process.

Thus, by re-arranging the respective instances of the set of time-independent operations for each GPU chip of the GPU cluster 121 to be executed either prior to or after the execution of the backward pass at each training iteration of the training process of the ML model 280, the server 250 can be configured to expedite the operations executed along the computation stream 402, saving computational resources of the server 250, which can translate into improved overall efficiency of the training process.

### Method

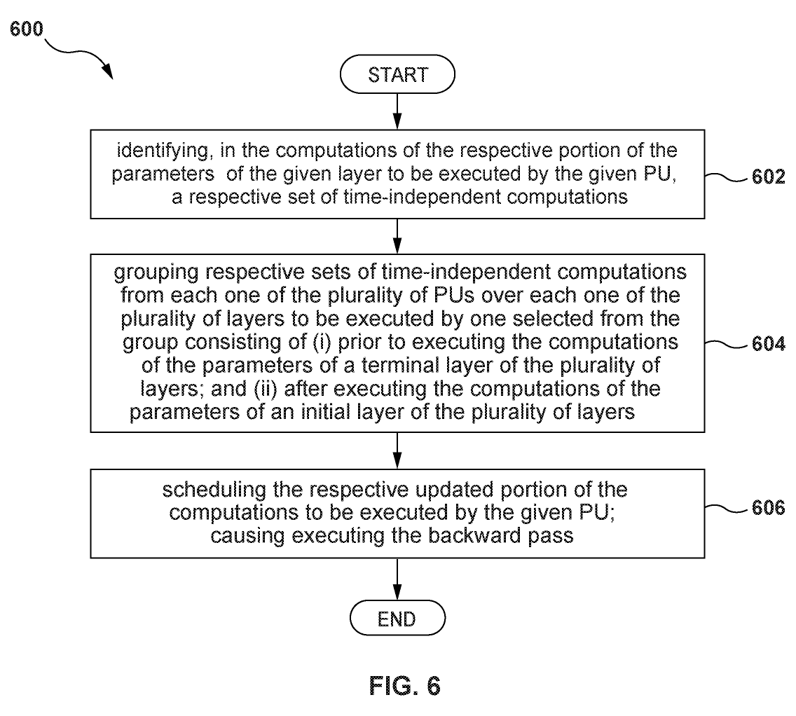

Given the architecture and the examples provided hereinabove, it is possible to execute a method for controlling computations performed during the backward pass of the training process of a given ML model, such as the ML model 280. With reference now to FIG. 6, there is depicted a flowchart of a method 600, according to certain non-limiting embodiments of the present technology. The method 600 may be executed by server 250 using one of the GPU cluster 121 of the GPU 111 and CPU cluster of the CPU 110.

As mentioned hereinabove, in some non-limiting embodiments of the present technology, the ML model 280 can comprise a NN. In some non-limiting embodiments of the present technology, the NN can comprise a Transformer-based NN, such as one of a GPT and a BERT Transformer-based NN. In some non-limiting embodiments of the present technology, the ML model 280 can comprise an LLM.

STEP 602: IDENTIFYING, IN THE COMPUTATIONS OF THE RESPECTIVE PORTION OF THE PARAMETERS OF THE GIVEN LAYER TO BE EXECUTED BY THE GIVEN PU, A RESPECTIVE SET OF TIME-INDEPENDENT COMPUTATIONS

At step 602, according to certain non-limiting embodiments of the present technology, prior to executing the backward pass of the given training iteration of the training process of the ML model 280, the server 250 can be configured to identify, for each GPU chip of the plurality of GPU cluster 121, such as the given GPU chip 131, the respective instance of the set of time-independent operations.

According to certain non-limiting embodiments of the present technology, as described in detail above with reference to FIG. 4, the server 250 can be configured to identify the respective instance of the set of time-independent operations from the plurality of auxiliary operations 407 executed by the given GPU chip 131 between the respective instances of the gather operation 401 and the synchronization operation 405.

According to certain non-limiting embodiments of the present technology, as described in detail further above with reference to FIG. 4, the set of time-independent operations can include, without limitation: (1) the first time-independent operation including the pre-division of the gradients of the parameters of the given layer of the ML model 280; (2) the second time-independent operation including computation of gradients of the learnable parameters of the LayerNorm operation for the parameters of the given layer; and (3) the third time-independent operation including computation of gradients of the learnable parameters of the RMSNorm operation for the parameters of the given layer.

The method 600 hence advances to step 604.

STEP 604: GROUPING RESPECTIVE SETS OF TIME-INDEPENDENT COMPUTATIONS FROM EACH ONE OF THE PLURALITY OF PUS OVER EACH ONE OF THE PLURALITY OF LAYERS TO BE EXECUTED BY ONE SELECTED FROM THE GROUP CONSISTING OF (I) PRIOR TO EXECUTING THE COMPUTATIONS OF THE PARAMETERS OF A TERMINAL LAYER OF THE PLURALITY OF LAYERS; AND (II) AFTER EXECUTING THE COMPUTATIONS OF THE PARAMETERS OF AN INITIAL LAYER OF THE PLURALITY OF LAYERS

At step 604, according to certain non-limiting embodiments of the present technology, the server 250 can be configured to group and re-arrange the respective instances of the set of time-independent operations determined for each GPU chip of the GPU cluster 121 at step 602 to be executed one of: (i) prior to executing the backward pass of the given training iteration, that is prior to computing the gradients of parameters of the terminal layer of the ML model 280; and (ii) after the backward pass of the given training iteration of the training process, that is, after computing the gradients of the parameters of the initial layer of the ML model 280.

More specifically, according to some non-limiting embodiments of the present technology, the server 250 can be configured to group all instances of the first time-independent operation (that is, the pre-division operation) across the plurality of layers after executing the gradient computation operation 403 on the initial layer of the ML model 280. In other words, the server 250 can be configured to move all the instances of the first time-independent operation to after all the instances of the gradient computation operations 403 on each one of the plurality of layers of the ML model 280 have been executed.

Further, according to certain non-limiting embodiments of the present technology, the server 250 can further be configured to: (i) group all the learnable parameters of the second time-independent operation, that is, the LayerNorm operation, across all layers of the ML model 280 in the beginning of the given training iteration, that is, prior to executing the forward pass; and (ii) compute the gradients of the learnable parameters of the second time-independent operation after the backward pass of the training process.

Further, in some non-limiting embodiments of the present technology, similar to the second time-independent operation, the server 250 can further be configured to: (i) group all the learnable parameters of the third time-independent operation, that is, the RMSNorm operation, in the beginning of the given training iteration, that is, prior to executing the forward pass; and (ii) compute the gradients of all the learnable parameters of the third time-independent operation after the backward pass of the given training iteration of the training process.

By grouping and re-arranging the respective instances of the set of time-independent operations, as described in detail above with reference to FIG. 5, the server 250 can be configured to generate the updated plurality of auxiliary operations 507 between the respective instances of the gather and synchronization operations 401, 405 for the given GPU chip 131. The updated plurality of auxiliary computations 507 is smaller than the plurality of auxiliary computations 407, which minimizes the gap 409 between the respective instances of the gather and synchronization operations 401, 405 for the given GPU chip 131 in the communication stream 404; thereby expediting the execution of the respective instances of the gradient computation operation 403 by each GPU chip of the GPU cluster in the computation stream 402.

The method 600 hence advances to step 606.

STEP 606: SCHEDULING THE RESPECTIVE UPDATED PORTION OF THE COMPUTATIONS TO BE EXECUTED BY THE GIVEN PU; CAUSING EXECUTING THE BACKWARD PASS

At step 606, according to certain non-limiting embodiments of the present technology, the server 250 can be configured to schedule, for each GPU chip of the GPU cluster 121, the respective instance of: (1) the gather operation 401; (2) the gradient computation operation 403; (3) the updated plurality of auxiliary operations 507; and (4) the synchronization operation 405.

Further, the server 250 can be configured to schedule the respective instances of the set of time-independent operations to be executed one of prior to and after the backward pass, as described above, to be executed by the GPU cluster 121 akin to executing other operations described above.

Further, the server 250 can be configured to cause the execution of the so designed backward pass of the given training iteration of the training process of the ML model 280.

The method 600 hence terminates.

Thus, by grouping the instances of the set of time-independent computations for bulk execution either prior to or after the execution of the backward pass of the given training iteration of the training process of the ML model 280, certain embodiments of the method 600 may help improve the overall efficiency of the training process and save the computational resources of the GPU cluster 121. This may enable scalability of the ML model 280.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

While the above-described implementations have been described and shown with reference to particular steps performed in a particular order, it will be understood that these steps may be combined, sub-divided, or re-ordered without departing from the teachings of the present technology. Accordingly, the order and grouping of the steps is not a limitation of the present technology.

1. A method for controlling computations performed during a backward pass of a training process of a given machine-learning (ML) model, the training process being executed using a plurality of processing units (PUs) such that a given PU of the plurality of PUs is configured to execute computations of a respective portion of parameters of a given layer of a plurality of layers of the given ML model, the method comprising,
prior to executing the backward pass:
identifying, in the computations of the respective portion of the parameters of the given layer to be executed by the given PU, a respective set of time-independent computations,
a given time-independent computation of the set of time-independent computations being to be executed without influencing the computations of the parameters on any other layer of the plurality of layers of the given ML model;
grouping respective sets of time-independent computations from each one of the plurality of PUs over each one of the plurality of layers to be executed by one selected from the group consisting of (i) prior to executing the computations of the parameters of a terminal layer of the plurality of layers; and (ii) after executing the computations of the parameters of an initial layer of the plurality of layers, thereby:
removing the set of time-independent computations from the computations of the respective portion of parameters to be executed by the given PU; and
generating a respective updated portion of the computations, without the set of time-independent computations, to be executed by the given PU;
scheduling the respective updated portion of the computations to be executed by the given PU; and
causing executing the backward pass.

2. The method of claim 1, wherein the given ML model is a neural network.

3. The method of claim 2, wherein the neural network is a Transformer-based neural network.

4. The method of claim 3, wherein the Transformer-based neural network is a Large Language Model (LLM).

5. The method of claim 1, wherein the given PU is a Graphics PU (GPU).

6. The method of claim 1, wherein the set of time-independent computations includes at least one selected from the group consisted of: (i) computations of learnable parameters of a Root Mean Square Layer Normalization (RMSNorm) computation of the given layer; (ii) computations of learnable parameters of a Layer Normalization (LayerNorm) computation of the given layer; and (iii) and a pre-division of gradients of the given layer.

7. The method of claim 6, further comprising executing the pre-division of the gradients of each one of the plurality of layers after the executing the computations of the parameters of the initial layer of the plurality of layers during the backward pass.

8. The method of claim 6, further comprising:
grouping the learnable parameters of the RMSNorm and LayerNorm computations across each one of the plurality of layers prior to the executing the computations of the parameters of the terminal layer of the plurality of layers during the backward pass; and
reducing gradients of the learnable parameters of the RMSNorm and LayerNorm computations after the executing the computations of the parameters of the initial layer of the plurality of layers during the backward pass.

9. The method of claim 8, wherein the grouping the learnable parameters of the RMSNorm and LayerNorm computations across each one of the plurality of layers prior to the executing the computations of the parameters of the terminal layer of the plurality of layers comprises grouping the learnable parameters of the RMSNorm and LayerNorm computations across each one of the plurality of layers prior to executing a forward pass of the training process, the forward pass being executed prior to the executing the backward pass of the training process.

10. The method of claim 6, wherein the learnable parameters of the RMSNorm and LayerNorm computations include at lats one selected from the group consisting of: (i) a scaling parameter; and (ii) a shifting parameter.

11. A server for controlling computations performed during a backward pass of a training process of a given machine-learning (ML) model, the training process being executed using a plurality of processing units (PUs) such that a given PU of the plurality of PUs is configured to execute computations of a respective portion of parameters of a given layer of a plurality of layers of the given ML model,
the server comprising at least one processor and at least one non-transitory computer-readable memory, storying executable instructions, which, upon execution by the at least one processor, cause the server to:
prior to executing the backward pass:
identify, in the computations of the respective portion of the parameters of the given layer to be executed by the given PU, a respective set of time-independent computations,
a given time-independent computation of the set of time-independent computations being to be executed without influencing the computations of the parameters on any other layer of the plurality of layers of the given ML model;
group respective sets of time-independent computations from each one of the plurality of PUs over each one of the plurality of layers to be executed by one selected from the group consisting of (i) prior to executing the computations of the parameters of a terminal layer of the plurality of layers; and (ii) after executing the computations of the parameters of an initial layer of the plurality of layers, thereby:
removing the set of time-independent computations from the computations of the respective portion of parameters to be executed by the given PU; and
generating a respective updated portion of the computations, without the set of time-independent computations, to be executed by the given PU;
schedule the respective updated portion of the computations to be executed by the given PU; and
cause executing the backward pass.

12. The server of claim 11, wherein the given ML model is a neural network.

13. The server of claim 12, wherein the neural network is a Transformer-based neural network.

14. The server of claim 13, wherein the Transformer-based neural network is a Large Language Model (LLM).

15. The server of claim 11, wherein the given PU is a Graphics PU (GPU).

16. The server of claim 11, wherein the set of time-independent computations includes at least one selected from the group consisted of: (i) computations of learnable parameters of a Root Mean Square Layer Normalization (RMSNorm) computation of the given layer; (ii) computations of learnable parameters of a Layer Normalization (LayerNorm) computation of the given layer; and (iii) and a pre-division of gradients of the given layer.

17. The server of claim 16, wherein the executable instructions further cause the server to execute the pre-division of the gradients of each one of the plurality of layers after the executing the computations of the parameters of the initial layer of the plurality of layers during the backward pass.

18. The server of claim 16, wherein the executable instructions further cause the server to:
group the learnable parameters of the RMSNorm and LayerNorm computations across each one of the plurality of layers prior to the executing the computations of the parameters of the terminal layer of the plurality of layers during the backward pass; and
reduce gradients of the learnable parameters of the RMSNorm and LayerNorm computations after the executing the computations of the parameters of the initial layer of the plurality of layers during the backward pass.

19. The server of claim 18, wherein to group the learnable parameters of the RMSNorm and LayerNorm computations across each one of the plurality of layers prior to the executing the computations of the parameters of the terminal layer of the plurality of layers the executable instructions cause the server to group the learnable parameters of the RMSNorm and LayerNorm computations across each one of the plurality of layers prior to executing a forward pass of the training process, the forward pass being executed prior to the executing the backward pass of the training process.

20. The server of claim 16, wherein the learnable parameters of the RMSNorm and LayerNorm computations include at lats one selected from the group consisting of: (i) a scaling parameter; and (ii) a shifting parameter.
